(19) United States
(12) Patent Application Publication
(10) Pub. No.: US 2021/0209267 A1
(43) Pub. Date: Jul. 8, 2021

(54) CREATION OF AN INTERDISCIPLINARY SIMULATION MODEL

(71) Applicant: Siemens Aktiengesellschaft, Munich (DE)

(72) Inventors: Thomas Baudisch, Schondorf am Ammerse (DE); Veronica Brandstetter, München (DE); Tim Schenk, Landshut (DE); Jan Christoph Wehrstedt, München (DE)

(21) Appl. No.: 17/057,405

(22) PCT Filed: Apr. 30, 2019
(86) PCT No.: PCT/EP2019/061075

§ 371 Date: Nov. 20, 2020

(30) Foreign Application Priority Data
May 24, 2018 (EP) 18174075.4

(51) Int. Cl. G06F 30/20

(52) U.S. Cl. CPC G06F 30/20; G06F 2111/10

(57) ABSTRACT

A computer-supported creation of an interdisciplinary simulation model of a physical-technical device is provided. Based on a predefined database, which is indicative of the physical-technical behaviour of the device, discipline-specific simulation components of the device and at least one interface for each of the simulation components are created, such that statuses of the simulation components can be synchronised with one another by means of the interfaces. In addition, each discipline-specific simulation component models a corresponding discipline-specific aspect of the physical-technical behaviour of the device. The created simulation components represent the simulation model together with the interfaces.

### CROSS-REFERENCE TO RELATED APPLICATIONS

This application claims priority to PCT Application No. PCT/EP2019/061075, having a filing date of Apr. 30, 2019, which is based off of European Patent Application No. 18174075.4, having a filing date of May 24, 2018, the entire contents both of which are hereby incorporated by reference.

### FIELD OF TECHNOLOGY

The following relates to the automatic creation of an interdisciplinary simulation model for a physical-technical device.

### BACKGROUND

“Architecture for modelling and simulation of technical systems along their lifecycle”, by T. Schenk et al., Computing and Visualization in Science, Springer, vol. 17, No. 4, pages 167-183, describes the modelling and simulation of a technical system. A simulation architecture is presented and is discussed on the basis of various industrial applications.

“Multi-physics electric motor simulation workflow”, by J. Goss, dated Oct. 13, 2017, retrieved from the Internet at https://www.cadfemulandireland.com/wp-content/uploads/2018/01/Electric-Drive-Complete-Solution_CADFEM_Ireland_Oct17.pdf, describes the development of motor CAD software for designing an electric motor. In this regard, modules are designed for electromagnetic and electric power and for thermal calculations.

“Modelling and Simulation of Multi Domain Physical Systems”, by S. Chandrachood, Matlab Expo 2013, discloses the modelling of an installation, wherein a simulation environment is provided for physical systems having mechanical, electrical and hydraulic domains.

Dynamic system simulation involves different aspects (i.e. domains or disciplines, such as e.g. thermal attributes and electrical attributes) of a system or device being considered. These different aspects or domains are frequently analyzed using what are known as co-simulation approaches, which involve one discipline-specific simulation model or one discipline-specific simulation component being used for each aspect. These discipline-specific simulation components, which in turn can consist of individual connected instances of simulation components, are coupled using co-simulation techniques. That is to say that relevant results from each discipline-specific simulation component are made available at specific simulation times and are then used by the other discipline-specific simulation component/s as an input for the next time step. The respective discipline-specific simulation component then uses these inputs for calculation so as for its part to calculate its results (for the next data interchange) at the next specific simulation time.

Today, the discipline-specific simulation created, independently of one another, essentially manually by applicable experts in the aspect corresponding to the discipline-specific simulation component. It is then necessary to ensure that the respectively created discipline-specific simulation component is couplable to other discipline-specific simulation components, in order to realize the data interchange described above and hence to ensure a functioning co-simulation.

### SUMMARY

The present invention is based on the object of harmonizing and automating the creation of an interdisciplinary simulation model.

According to the embodiment of the present invention, this object is achieved by a method for creating an interdisciplinary simulation model by a computer, by a computer program product (non-transitory computer readable storage medium having instructions, which when executed by a processor perform actions).and by an electronically readable data carrier

The present invention involves providing a computer-implemented method for creating an interdisciplinary simulation model of a physical-technical device. The method according to the present invention includes the following steps, which are based on a stipulated database that can be used to ascertain statements about the physical-technical behavior of the device:

creating discipline-specific simulation components of the device. Each of these discipline-specific simulation components models a corresponding discipline-specific aspect of the physical-technical behavior of the device. Discipline-specific aspects can be for example electrostatic, magnetic, electromagnetic, electrical, thermodynamic, mechanical, hydraulic, automated, etc., aspects.

Creating one or more interfaces for each of the created simulation components, so that states of the simulation components can be synchronized to one another by means of these interfaces. By means of these interfaces, it is accordingly possible to make available outputs of one simulation component as inputs for another simulation component.

The created simulation components together with the interfaces form the interdisciplinary simulation model.

As a result of the discipline-specific simulation components and the interfaces connecting them being automatically created from the database storing the physical-technical behavior of the device to be simulated, in the end the interdisciplinary simulation model is also created automatically. This simulation model created according to embodiments of the present invention can then be used to perform a co-simulation in which the different discipline-specific aspects of the device are modelled and simulated in a distributed manner (i.e. with the different discipline-specific simulation components), the interaction between the different domains being modelled on the basis of the discipline-specific simulation components coupled via the interfaces.

In this instance a database is understood to mean any storage location for data (e.g. including in a cloud). By way of example, this database or this storage location can be an engineering tool from which the physical-technical behavior of the device can be taken in any form.

According to embodiments of the present invention, Web or cloud applications are also supported. That is to say that the method according to the present invention can also be performed in web-based or cloud-based fashion.

The creating of at least one of the simulation components including in particular creating a functional model of the behavior of the physical-technical device in the discipline or in regard to the aspect of this simulation component. Output values of the respective simulation component are determined by means of this functional model at specific simulation times on the basis of input values for the same simulation component. The output values can then be provided as input values for another simulation component, whose input side is connected to the simulation component.

The output values created by the simulation component by means of the functional model can therefore be used by the other simulation component as input values in order to calculate the output values of the other simulation component at the same simulation time or at the next simulation time using the functional model of the other simulation component.

The functional model can include for example a numerical simulation on the basis of physical differential equations and/or signal-flow-based descriptions and/or discrete system descriptions.

In addition, the functional model can include a stipulated analytical dependency and/or boundary values for one or for multiple simulation components.

The stipulated analytical dependency and/or the boundary values is/are produced in particular on the basis of a plausibility check that is used to check an interoperability between different instances of the simulation components taking into consideration the interfaces.

Boundary values need to be set for simulation components, for example, if these boundary values relate to interfaces to other domains that are not relevant to the interdisciplinary simulation model to be created or are not explicitly intended to be simulated. The need to set boundary values can be ascertained automatically on the basis of the plausibility check, for example.

Furthermore, initial values can be stipulated as input values for specific simulation components at the first simulation time.

The interfaces are in particular created as a function mockup interface (FMI) within the context of the FMI standard. The interfaces can also generally be co-simulation interfaces, however.

The discipline-specific simulation components can be detected or automatically created from an associated physical component of the device to be simulated.

If the simulation components are automatically created from one or more applicable physical components of the device to be simulated, the database that is indicative of the physical-technical behavior of the device contains for example information for a planning tool or engineering tool (e.g. COMOS COMponent Object Server)) in regard to this/these physical component/s. The device to be simulated can include one or more interacting physical components for the planning tool (e.g. a piece of system simulation software). Each of these physical components usually includes multiple discipline-specific components in order to model the behavior of the respective physical component for the planning tool in the applicable domain. The associated discipline-specific simulation component can then be automatically created from a respective discipline-specific component.

The stipulated database can include an object-oriented library of this planning tool or of a configuration tool for installation control.

According to embodiments of the present invention, it is possible to stipulate the disciplines or domains that are to be considered, so that only those discipline-specific simulation components that correspond to these disciplines that are to be considered or that are stipulated are created for the device to be simulated.

This stipulation of the disciplines to be considered can be effected by means of a selection in the configuration tool, for example.

According to one embodiment according to the present invention, the creating of the interfaces includes automatically generating a respective coupling table for two of the simulation components whose interfaces are directly coupled from dependencies between the two disciplines of the simulation components that are stored in the stipulated database. The respective coupling table describes an interaction between the interfaces and hence between the directly coupled simulation components.

By way of example, a co-simulation master can read in the simulation components together with the coupling tables in order to take this as a basis for also creating the interfaces and hence the interdisciplinary simulation model.

Embodiments of the present invention also provides a computer that includes a processor and storage means. The processor is designed to execute a program code stored in the storage means. The execution of this program code creates an interdisciplinary simulation model of a physical-technical device. The computer is also designed so as, as a result of the execution of this program code, based on a stipulated database indicative of the physical-technical behavior of the device, to create discipline-specific simulation components of the device and at least one interface for each of these simulation components, so that states of the simulation components are synchronizable to one another by means of the interfaces. Each discipline-specific simulation component models an applicable discipline-specific aspect of the physical-technical behavior of the device. The created simulation components together with the interfaces are the simulation model.

The computer according to embodiments of the present invention may be designed so that the method according to the present invention is executed in web-based fashion or in a cloud.

The advantages of the computer according to embodiments of the present invention correspond to the advantages of the method according to the present invention that were set out in detail earlier, and so repetition is dispensed with at this juncture.

According to one embodiment according to the present invention, the computer is designed to use the previously created interdisciplinary simulation model to perform a simulation of the physical-technical device.

Furthermore, embodiments of the present invention describes a computer program product, in particular a piece of software, that can be loaded into a memory of a computer. This computer program product can be used to implement all or various previously described embodiments of the method according to the present invention when the computer program product is executed in the processor of the computer. For this, the computer program product may require program means, e.g. libraries and auxiliary functions, in order to realize the applicable embodiments of the method. In other words, the computer program product is a piece of software by means of which one of the embodiments described above for the method according to the present invention can be implemented or that implements this embodiment. The software in this case can be a source code (e.g. C++) that still needs to be compiled and linked or that only needs to be interpreted, or an executable software code that now just needs to be loaded into the applicable processor for execution.

Finally, embodiments of the present invention discloses an electronically readable data carrier, e.g. a DVD, a magnetic tape, a hard disk or a USB stick, on which electronically readable control information, in particular software (cf. above) is stored. When this control information (software) is read from the data carrier and stored in the computer, all of the present invention's embodiments of the previously described method can be performed.

Embodiments of the present invention allows co-simulations to be able to be created implicitly by a system engineering unit.

With planning tools or engineering tools (such as e.g. COMOS), every single component of the planning tool is designed in domain-specific fashion in preparation for a later coupling. Although domain-specific or discipline-specific components can be part of the same physical component of the device to be simulated from a configuration and engineering point of view (e.g. in COMOS), they can model different, discipline-specific behavior. By way of example, a motor has not only a control unit (which therefore represents software or automation) but also an electrical, mechanical, hydraulic, thermal, etc., behavior, which are all simulated in discipline-specific fashion.

Embodiment of the present invention more or less transfers the information from the planning tool (e.g. COMOS) to the world of simulation by specifying in advance for the planning tool, for each component of the device to be simulated, how the component-internal coupling of the disciplines presents itself.

In engineering tools, such as e.g. COMOS, the discipline-specific components of the device to be simulated are already modelled as described earlier. As will be explained in detail below with reference to the figures, producing an applicable component for a pump, for example, in the hydraulic perspective involves a discipline-specific or domain-specific representative being automatically produced in every further relevant domain, between which navigation is possible. That is to say that in the hydraulic perspective there is a representative or a discipline-specific component for a pump, which has two connections for the inflow and for the outflow. The properties of the component, which are able to be set for a pump, for example, correspond to the hydraulic properties, such as the pressure/flow characteristic curves and, in the case of regulated pumps, the speed dependency.

he Embodiment of the present invention firstly provides the opportunity to model simulation components of the simulation model for different domains or disciplines. Secondly, the interfaces between different discipline-specific simulation components can be automatically identified, so that the interfaces of the simulation components can be automatically generated in the form of co-simulation couplings, these couplings being directly and uniquely associated.

### BRIEF DESCRIPTION

Some of the embodiments will be described in detail, with reference to the following figures, wherein like designations denote like members, wherein:

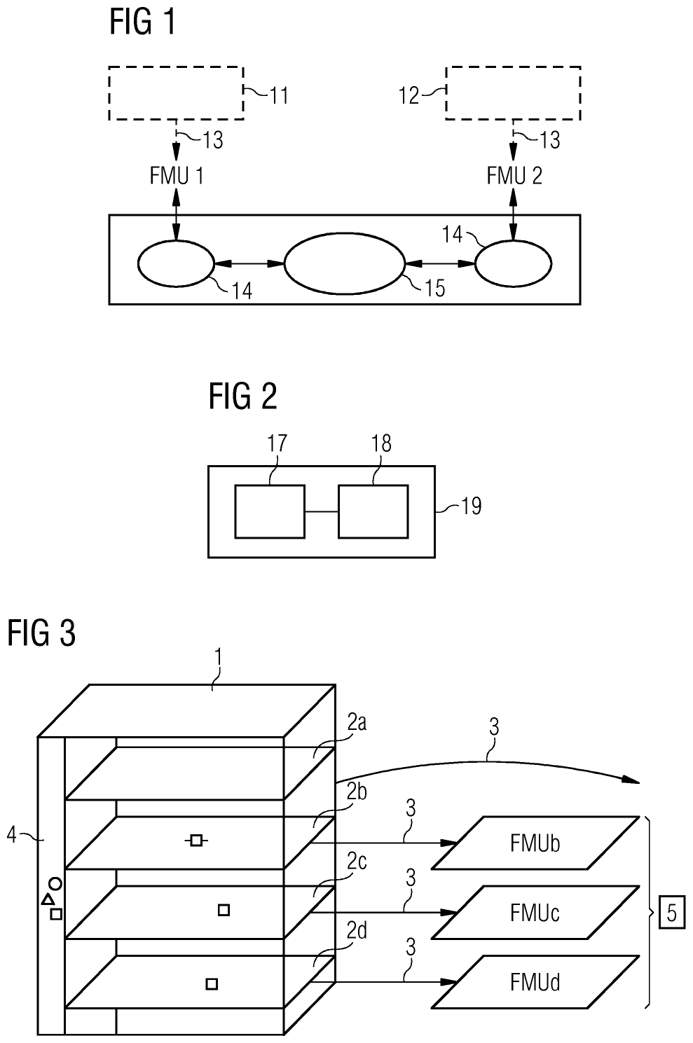

FIG. 1 depicts a co-simulation architecture according to the FMI standard;

FIG. 2 depicts a computer;

FIG. 3 depicts how discipline-specific simulation components are created from a planning tool;

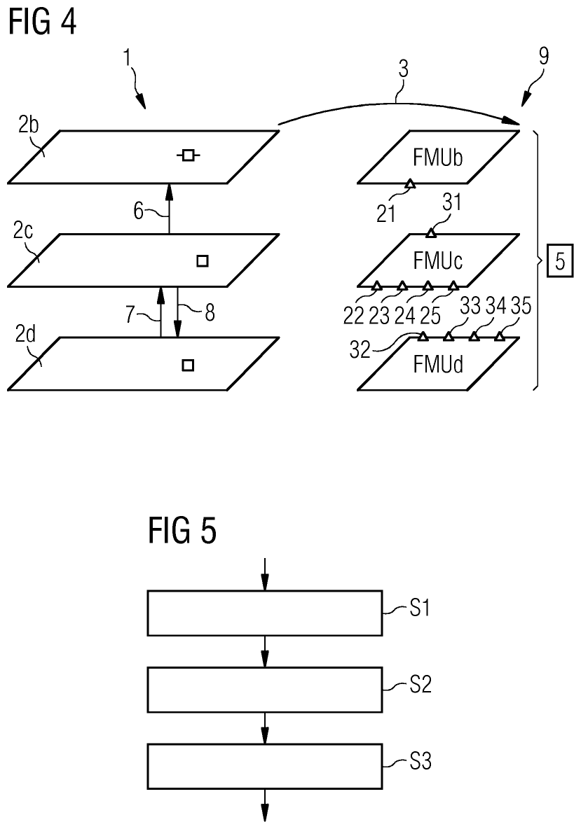

FIG. 4 depicts how discipline-specific simulation components and associated interfaces and hence the simulation model as a whole are created from a planning tool; and

FIG. 5 depicts a flowchart for a method.

### DETAILED DESCRIPTION

A first FMU 1 is exported from a first AMESim model 11 and a second FMU 2 is exported from a second AMESim model 12 in a preprocessing step. AMESim is simulation software for modelling and analysis of physical-technical devices in multiple domains. The first FMU 1 (“functional mockup unit”) and the second FMU 2 each interact with an FMI client 14 that in turn cooperates with a CosMOS master 15. It should be pointed out that AMESim, CosMOS and FMI are mentioned only by way of example and can be replaced, according to the present invention, by other applications or programs or interfaces.

It can be seen from FIG. 1 that the discipline-specific simulation models 11, 12 are modelled separately by domain experts in a simulation environment suitable therefor. Subsequently, these models 11, 12 are each published with a description of their interface, which can then be used for coupling the models 11, 12. The publication of the interface can be effected in the FMI standard, for example.

FIG. 2 depicts a computer 19 according to the present invention that includes a processor 17 and a memory 18. This computer 19 is designed to execute a program code stored in the memory 18 so as thereby to create, according to the present invention, an interdisciplinary simulation model of a physical-technical device.

FIG. 3 schematically depicts how discipline-specific simulation components FMUb-FMUd of an interdisciplinary simulation model are produced from a planning tool 1 for a physical-technical device by means of automatic generation 3.

The planning tool 1, for example a piece of system simulation software, includes not only a library 4 for each physical component of the device but also one or more discipline-specific components 2a-2d, which are more or less a domain-specific representative of each domain, between which it is possible to navigate.

In the case of the planning tool depicted in FIG. 3, the physical-technical device modelled is a pump that, for the purposes of simplification, includes only one physical component. That is to say that the pump is modulated only by means of one physical component.

This physical component, or the pump, is modelled on the basis of four discipline-specific components 2a-2d, wherein the first component 2a describes the electrical domain, the second component 2b describes the hydraulic domain, the third component 2c describes the mechanical domain and the fourth component 2d describes the automation domain.

In the embodiment depicted in FIG. 3, a discipline-specific simulation component FMUb-FMUd is automatically created for each of the three components 2b-2d. Additionally, a description 5 of the coupling of the created simulation components FMUb-FMUd is automatically produced from the four components 2a-2d.

FIG. 4 also schematically depicts how the simulation components FMUb-FMUd are produced for the physical-technical device from the planning tool 1 by means of automatic generation 3, wherein FIG. 4 additionally depicts the automatic creation of the interfaces 21-35 of the created simulation components FMUb-FMUd.

It can be seen that the component 2d, which is the automation of the pump, exchanges specific information 7, 8 with the component 2c, which is the mechanics (the drive behavior) of the pump. While the component 2d reports to the component 2c whether the pump is supposed to be switched on or switched off and delivers a preset value for the amount of substance to be pumped per unit time (see reference sign 7), the component 2c reports back to the component 2d the present speed at which the pump is operated, as indicated by the reference sign 8. In addition, the component 2c reports the present speed 6 to the component 2b, which is the hydraulics of the pump.

While the component 2c has no connections within the discipline, i.e. the individual component 2c, the component 2b has the incoming amount of substance (inflow) and the outgoing amount of substance (outflow) as connections within the discipline. The component 2d has the switching-on and the switching-off of the pump, the preset value for the amount of substance to be pumped by the pump per unit time and the feedback value from the mechanics 2c concerning the present speed at which the pump is operated as connections within the discipline.

Instead of the automation 2d, it is also possible to use pump schedules so as thereby to control the pump.

Using model creation techniques, all of the selected discipline-specific simulation components FMUb-FMUd of the interdisciplinary simulation model 9 of the pump can be automatically created from the configured system model or planning tool 1 of the pump. The definition of the interfaces 21-35, which are important for the co-simulation, is likewise effected automatically, which means that the simulation components FMUb-FMUd are coupled completely, this being stored on the basis of the description of the coupling 5 of the simulation components FMUb-FMUd. The interdisciplinary simulation model 9 of the physical-technical device, i.e. the pump, is therefore created completely.

In the example depicted in FIGS. 3 and 4, the pump is automatically switched on and switched off by the automation 2d, to which end the automation 2d sets the on output 32 and the off output 33 on its output interface as appropriate. Additionally, the automation 2d sets a speed, which is communicated on the output side by means of the speed output 31. The mechanics 2c read the information provided by the automation 2d via their input-side interfaces 21-23. Based on these specifications by the automation 2d, the motor of the pump can be set to the desired speed. The mechanics 2c report back the present speed to the automation 2d via their interface 25.

Based on the present speed of the pump, hydraulic dependencies of the pump can be determined on the basis of speed-dependent characteristic curves for the pump, for example.

FIG. 5 depicts the flowchart for a method according to the present invention for creating an interdisciplinary simulation model of a physical-technical device.

In the first step Si, discipline-specific components of a planning tool are created for the physical-technical device to be simulated (e.g. a pump). In the second step S2, simulation components are created for each relevant discipline-specific component of the device automatically, for example from the information of the planning tool. In the third step S3, the interfaces of the simulation components are automatically created in particular from information of the planning tool, as a result of which the simulation model is then created together with the simulation components.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

What is claimed:

1. A computer-implemented method for creating an interdisciplinary simulation model of a physical-technical device, the method comprising:
based on a stipulated database indicative of physical-technical behavior of the device: creating discipline-specific simulation components of the device, wherein each discipline-specific simulation component models a corresponding discipline-specific aspect of the physical-technical behavior of the device;
creating at least one interface for each of the simulation components, so that states of the simulation components are synchronizable to one another by means of the interfaces; and
wherein the created simulation components together with the interfaces are the simulation model.

2. The method as claimed in claim 1, wherein:
the creating of at least one of the simulation components comprises creating a functional model of the physical-technical behavior of the device in the respective discipline of the respective simulation component;
wherein an output value of the respective simulation component is determined by means of the functional model at specific simulation times in each case on the basis of an input value that is applied to the applicable at least one interface of the respective simulation component at the respective simulation time; and
wherein the output value of the respective simulation component is transferred to a further simulation component via the interface.

3. The method as claimed in claim 2, wherein the functional model comprises a numerical simulation for at least one of the simulation components on the basis of physical differential equations and/or signal-flow-based descriptions and/or discrete system descriptions.

4. The method as claimed in claim 2, wherein the functional model comprises a stipulated analytical dependency and/or boundary values for at least one of the simulation components.

5. The method as claimed in claim 4, wherein the stipulated analytical dependency and/or the boundary values is/are selected on the basis of a plausibility check on an interoperability between the simulation components on the basis of the interfaces.

6. The method as claimed in claim 1, wherein the interfaces are created as a functional mockup interface.

7. The method as claimed in claim 1:
wherein the discipline-specific simulation components are automatically created from an associated physical component of the device; or
in that the discipline-specific simulation components for the associated physical component of the device are detected.

8. The method as claimed in claim 1, wherein the stipulated database comprises an object-oriented library of a configuration tool for installation control.

9. The method as claimed in claim 1:
wherein it is stipulable which disciplines need to be considered; and
in that only those discipline-specific simulation components that correspond to the disciplines to be considered are created for the device.

10. The method as claimed in claim 1:
wherein the creating of the interfaces comprises automatically creating a respective coupling table for two of the simulation components whose interfaces are directly coupled from dependencies of the two simulation components that are described in the stipulated database; and
wherein the coupling tables describe an interaction between the interfaces.

11. A computer having a processor and storage means:
wherein the processor is designed to execute program code stored in the storage means so as thereby to create an interdisciplinary simulation model of a physical-technical device;
in order, based on a stipulated database indicative of the physical-technical behavior of the device, to create discipline-specific simulation components of the device, wherein each discipline-specific simulation component models a corresponding discipline-specific aspect of the physical-technical behavior of the device; and
to create at least one interface for each of the simulation components, so that states of the simulation components are synchronizable to one another by means of the interfaces;
wherein the created simulation components together with the interfaces are the simulation model.

12. The computer as claimed in claim 11, wherein the computer is designed to perform a simulation of the physical-technical device by using the interdisciplinary simulation model.

13. The computer as claimed in claim 11, wherein the computer is designed to perform the method.

14. A computer program product, comprising a computer readable hardware storage device having computer readable program code stored there, said program code executable by a processor of a computer system to implement the method as claimed in claim 1.

15. An electronically readable data carrier having electronically readable control information, stored thereon, that is designed to perform the method as claimed in claim 11 when the data carrier is used in a processor of a computer.
